(19) United States
(12) Patent Application Publication
(10) Pub. No.: US 2011/0066870 A1
(43) Pub. Date: Mar. 17, 2011

(54) PERIPHERAL CAPABLE OF CONNECTING WITH A HOST AND POWER CONTROL METHOD THEREOF

(76) Inventors: Hsing-Lu Chen, Hsinchu City (TW); Ying-Ming Chuang, Taoyuan County (TW)

(21) Appl. No.: 12/716,255

(22) Filed: Mar. 2, 2010

(30) Foreign Application Priority Data
Sep. 14, 2009 (TW) 098130947

(51) Int. Cl. G06F 1/32; G06F 1/00

(52) U.S. Cl. 713/324; 713/300

(57) ABSTRACT

A peripheral connected with a host via a transmission interface, and a power control method applied to the peripheral includes the steps of: receiving signal data from the host via the transmission interface; generating a power control signal when determining that the host and the peripheral are indifferent statuses; and selectively switching on or switching off an input power of the peripheral according to the power control signal, so as to make the peripheral change its status.

### BACKGROUND OF THE INVENTION

1. Field of the Invention

The present invention relates to a peripheral (e.g., a scanner) capable of connecting with a host (e.g., a computer) and a related power control method, and more particularly, to a device and a method for generating a power control signal by determining a status (a power-on status or a power-off status) of the host and for automatically switching on or switching off an input power of the peripheral according to the power control signal.

2. Description of the Prior Art

As far as certain peripherals of computers are concerned, such as a scanner, a printer, or a multi-function printer (MFP), their action modes of controlling power on/off statuses must be implemented by switching a power button in a manual manner. However, the peripheral operated with such action modes has the following disadvantages. When the peripheral is not in use, the peripheral is continuously in the device power-on status if the user does not have the habit of powering off the peripheral. Correspondingly, the lifetime and hours of use of internal electronic components (e.g., lamps or sensors) of the peripheral will be reduced, which results in unnecessary power consumption as well.

Hence, how to improve the life time of the internal electronic components of the peripheral, how to save power consumption, and how to increase more additional features to the peripheral have become one of the important topics in this field.

### SUMMARY OF THE INVENTION

It is one of the objectives of the present invention to provide a peripheral capable of connecting with a host and a related power control method to solve the above-mentioned problems.

The present invention discloses a power control method for a peripheral, wherein the peripheral connects with a host via a transmission interface. The power control method includes the steps of: receiving signal data from the host via the transmission interface; determining a status of the host as a power-on status according to the signal data and a status of the peripheral as a device power-off status, and then generating a power control signal; and switching on an input power of the peripheral according to the power control signal, so as to make the peripheral enter a device power-on status from the device power-off status.

The present invention further discloses a power control method for a peripheral, wherein the peripheral connects with a host via a transmission interface. The power control method includes the steps of: receiving signal data from the host via the transmission interface; determining a status of the host as a power-off status according to the signal data and a status of the peripheral as a device power-on status, and then generating a power control signal; and switching off an input power of the peripheral according to the power control signal, so as to make the peripheral enter a device power-off status from the device power-on status.

The present invention further discloses a peripheral capable of connecting with a host. The peripheral includes a transmission interface, a detecting unit, and a switch unit. The transmission interface is used for receiving signal data from the host, wherein the power control circuit couples with the host via the transmission interface. The detecting unit is coupled to the transmission interface, for determining a status of the host according to values of the signal data and for generating a power control signal. The switch unit is coupled to the detecting unit, for selectively switching on or switching off an input power of the peripheral according to the power control signal. Herein when the detecting unit determines the status of the host as a power-on status, and the status of the peripheral as a device power-off status, the detecting unit outputs the power control signal to control the switch unit to switch on the input power, such that the peripheral enters a device power-on status from the device power-off status. Otherwise, when the detecting unit determines the status of the host as a power-off status, and the status of the peripheral as the device power-on status, the detecting unit outputs the power control signal to control the switch unit to switch off the input power, such that the peripheral enters the device power-off status from the device power-on status.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a peripheral capable of connecting with a host according to a first embodiment of the present invention.

FIG. 2 is a diagram showing a peripheral capable of connecting with a host according to a second embodiment of the present invention.

FIG. 3A and FIG. 3B are respectively a flowchart illustrating a power control method for a peripheral according to a first exemplary embodiment of the present invention.

FIG. 4A and FIG. 4B are respectively a flowchart illustrating a power control method for a peripheral according to a second exemplary embodiment of the present invention.

### DETAILED DESCRIPTION

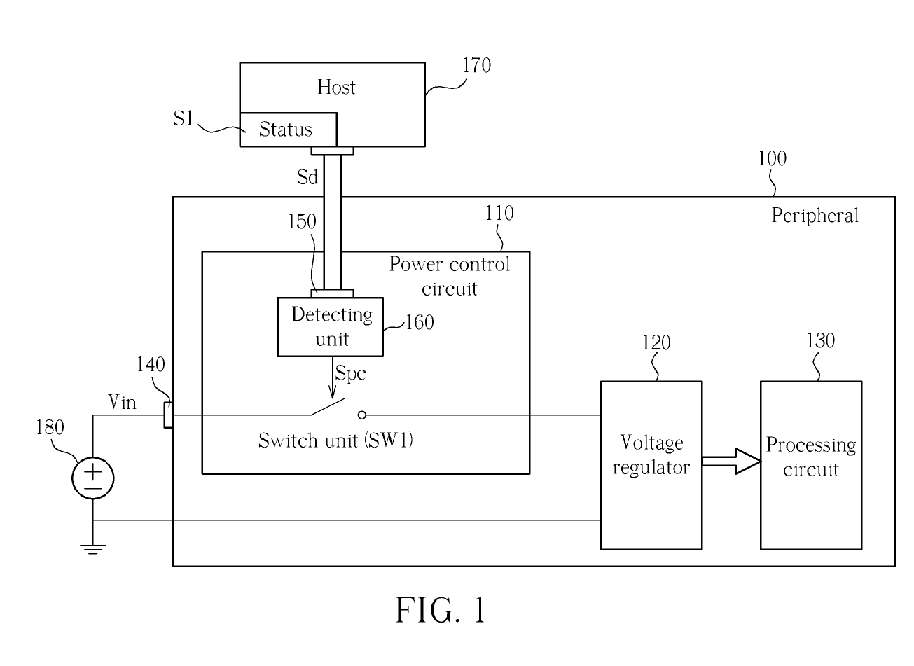

Please refer to FIG. 1. In this embodiment, the peripheral 100 couples with a host 170 via a transmission interface 150. The peripheral 100 includes a power control circuit 110, a voltage regulator 120, a processing circuit 130, and a power input port 140. Herein the power input port 140 is coupled to a power supply 180, for receiving an input power Vin (e.g., a DC voltage with 24V) outputted by the power supply 180 in order to supply needed power to the peripheral 100. The power control circuit 100 is coupled to the power input port 140 and the voltage regulator 120, and the power control circuit 100 has a transmission interface 150, a detecting unit 160, and a switch unit SW1. The transmission interface 150 is used for receiving signal data Sd from the host 170, and the power control circuit 110 couples with the host 170 via the transmission interface 150. In addition, the detecting unit 160 is coupled to the transmission interface 150, for determining a status S1 of the host 170 according to values (such as, “0” or “1”) of the signal data Sd and for generating a power control signal Spc to the switch unit SW1. The switch unit SW1 is coupled to the detecting unit 160 and the power input port 140, for selectively switching on or switching off the input power Vin inputted into the peripheral 100 according to the power control signal Spc.

For example, the signal data Sd received from the host 170 consists of a plurality of signal values. When at least one value of the signal data Sd is equal to 1, the detecting unit 160 determines that the status S1 of the host 170 as a power-on status. At this time, if the peripheral 100 is in a device power-off status, the detecting unit 160 outputs a power control signal Spc to control the switch unit SW1 to switch on the input power Vin, such that the peripheral 100 enters a device power-on status from the device power-off status. On the other hand, when all values of the signal data Sd are equal to 0, the detecting unit 160 determines that the status S1 of the host 170 as a power-off status. At this time, if the peripheral 100 is under the device power-on status, the detecting unit 160 outputs the power control signal Spc to control the switch unit SW1 to switch off the input power Vin, such that the peripheral 100 enters the device power-off status from the device power-on status.

Furthermore, the voltage regulator 120 is coupled to the switch unit SW1 of the power control circuit 110, for regulating the input power Vin passing through the switch unit SW1, and for distributing and transforming the input power Vin into required power of the processing circuit 130, such that the processing circuit 130 is able to perform operations of the peripheral 100. As an illustration, the voltage regulator 120 can distribute and transform a DC voltage with 24V into a DC voltage with 12V/5V/3.3V/2.5V. The processing unit 130 is coupled to the voltage regulator 120, for receiving the distributed/transformed voltage in order to perform the operating procedures of the peripheral 100.

The peripheral 100 may be an image processing device, such as: a scanner, a printer, or a multi-function printer (MFP). And thus the processing circuit 130 may be a scanner control circuit, used for performing a scanning procedure.

In one embodiment, the above-mentioned transmission interface 150 may be a USB interface and includes a D+ port and a D− port, and thus the detecting unit 160 can detect the signal data Sd via the D+ port and the D− port. As a result, when the detecting unit 160 detects that at least one value of the signal data Sd received by the D+ port and the D− port is equal to 1, the status S1 of the host 170 is determined as the power-on status; and when the detecting unit 160 detects that both the values of the signal data Sd received by the D+ port and the D− port are equal to 0, the status S1 of the host 170 is determined as the power-off status.

What's more, the above-mentioned detecting unit 160 can be implemented by a single USB Hub control circuit, or by the USB Hub control circuit coordinating with a USB device control circuit, but the present invention is not limited to this only.

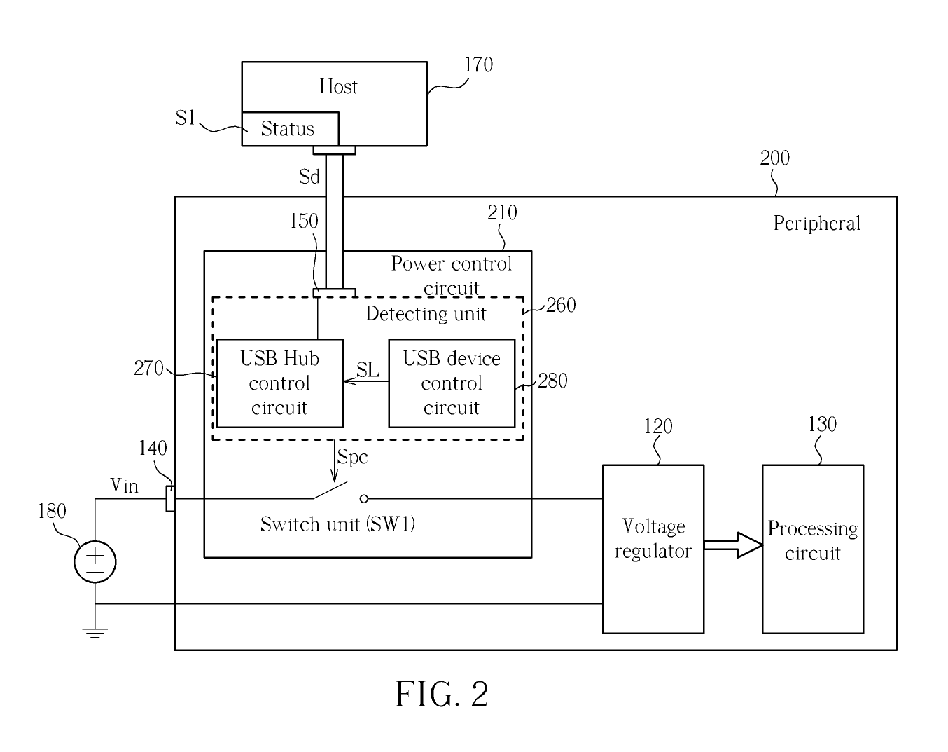

Please refer to FIG. 2. The difference between FIG. 2 and FIG. 1 is that: a detecting unit 260 of the peripheral 200 is implemented by the USB Hub control circuit 270 coordinating with the USB device control circuit 280. Herein the USB Hub control circuit 270 is coupled to the transmission interface 150, for detecting the signal data Sd received by the D+ port and the D− port; while the USB device control circuit 280 is coupled to the USB Hub control circuit 270, for detecting the signal data Sd via the USB Hub control circuit 270. As an illustration, under a condition that the peripheral 200 is in the device power-off status, if at least one value of the signal data Sd is detected to be equal to 1, the USB device control circuit 280 outputs a link confirmed signal SL to the USB Hub control circuit 270 for confirming that the USB device control circuit 280 and a hard disk (not shown) of the host 170 are linked. At this time, when the USB Hub control circuit 270 detects that at least one value of the signal data Sd is equal to 1 and the link confirmed signal SL has been received, it determines that the status S1 of the host 170 as the power-on status and then outputs the power control signal Spc to control the switch unit SW1 to switch on the input power Vin. On the other hand, under a condition that the peripheral 200 is in the device power-on status, if both the signal values of the signal data Sd are detected to be equal to 0, the USB Hub control circuit 270 determines that the status S1 of the host 170 as the power-off status and then outputs the power control signal Spc to control the switch unit SW1 to switch off the input power Vin.

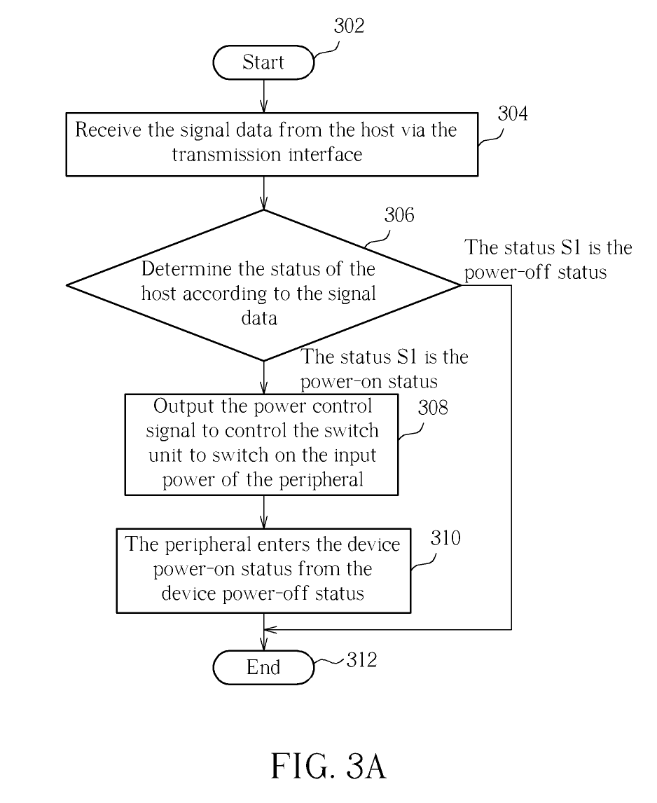

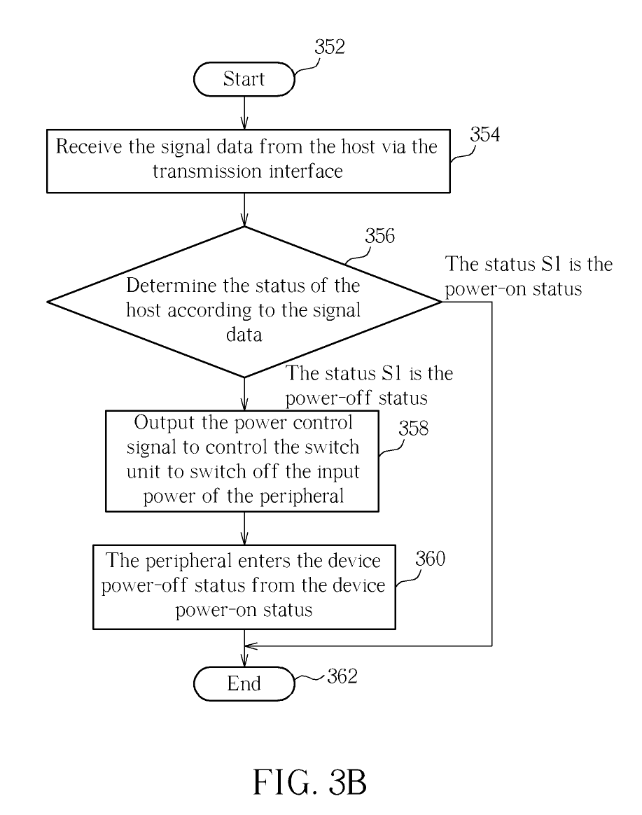

Please refer to FIG. 3A and FIG. 3B by collocating with the corresponding elements shown in FIG. 1 in the meantime. Herein FIG. 3A is a flowchart representing how to switch on the input power Vin of the peripheral 100 under a condition that the peripheral 100 is in the device power-off status; while FIG. 3B is a flowchart representing how to switch off the input power Vin of the peripheral 100 under a condition that the peripheral 100 is in the device power-on status.

As shown in FIG. 3A, the method includes the following steps:

Step 302: Start.

Step 304: Receive the signal data from the host via the transmission interface.

Step 306: Determine the status of the host according to the signal data. When determining that the status of the host is the power-on status, go to the step 308; otherwise, when determining that the status of the host is the power-off status, go to the step 312.

Step 308: Output the power control signal to control the switch unit to switch on the input power of the peripheral.

Step 310: The peripheral enters the device power-on status from the device power-off status.

Step 312: End.

As shown in FIG. 3B, the method includes the following steps:

Step 352: Start.

Step 354: Receive the signal data from the host via the transmission interface.

Step 356: Determine the status of the host according to the signal data. When determining that the status of the host is the power-off status, go to the step 358; otherwise, when determining that the status of the host is the power-on status, go to the step 362.

Step 358: Output the power control signal to control the switch unit to switch off the input power of the peripheral.

Step 360: The peripheral enters the device power-off status from the device power-on status.

Step 362: End.

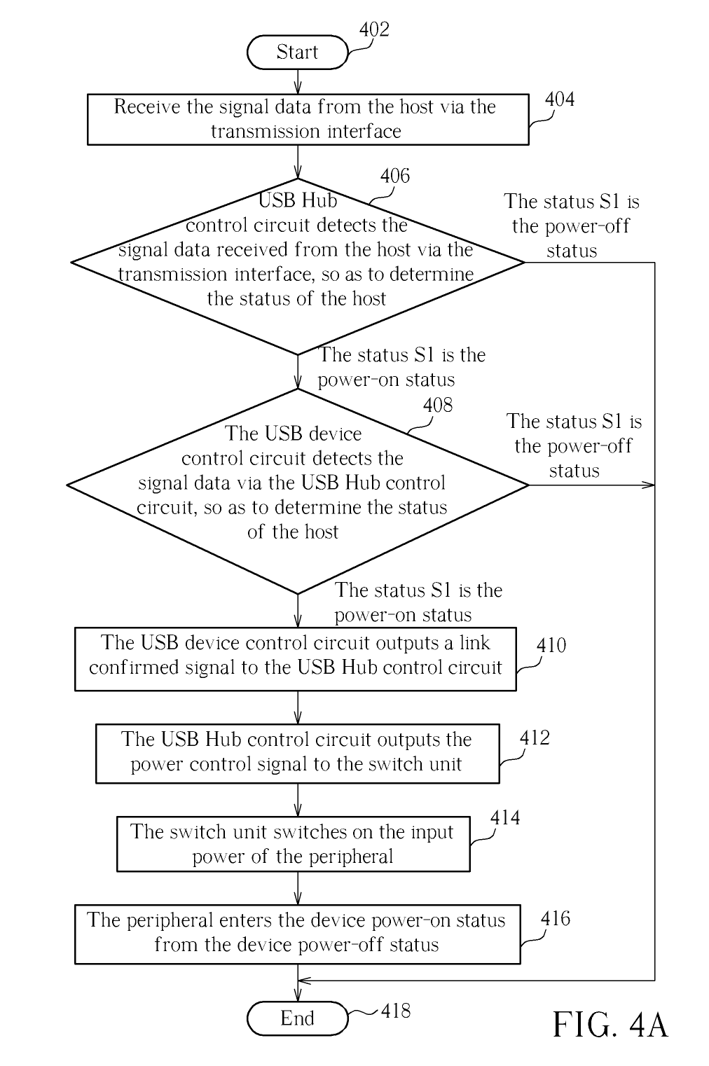

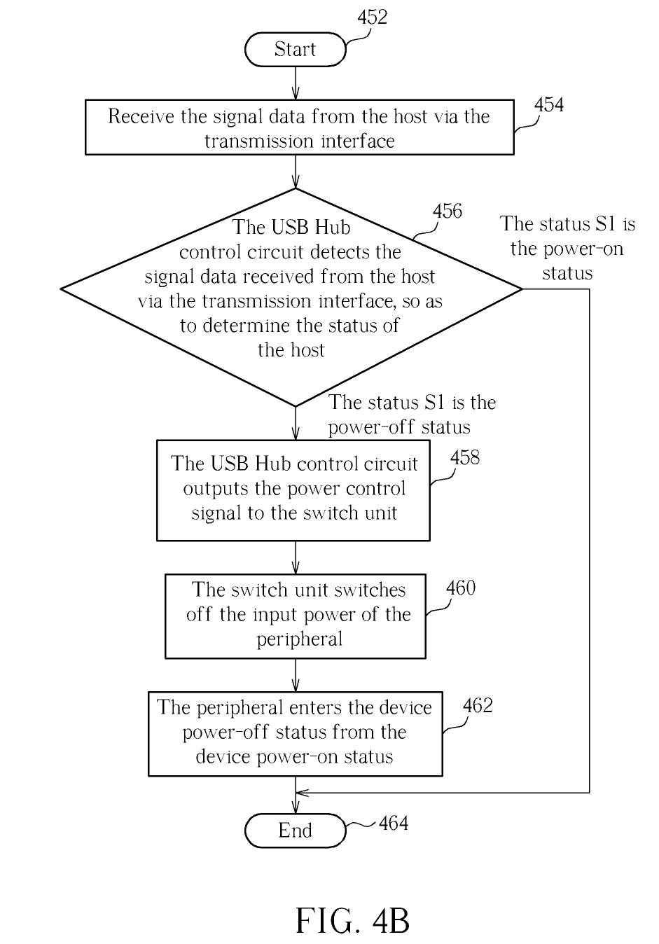

Please refer to FIG. 4A and FIG. 4B by collocating with the corresponding elements shown in FIG. 2 in the meantime. Herein FIG. 4A is a flowchart representing how to switch on the input power Vin of the peripheral 200 under a condition that the peripheral 200 is in the device power-off status; while FIG. 4B is a flowchart representing how to switch off the input power Vin of the peripheral 200 under a condition that the peripheral 200 is in the device power-on status.

As shown in FIG. 4A, the method includes the following steps:

Step 402: Start.

Step 404: Receive the signal data from the host via the transmission interface.

Step 406: The USB Hub control circuit detects the signal data received from the host via the transmission interface, so as to determine the status of the host. When determining that the status of the host is the power-on status, go to the step 408; otherwise, when determining that the status of the host is the power-off status, go to the step 418.

Step 408: The USB device control circuit detects the signal data via the USB Hub control circuit, so as to determine the status of the host. When determining that the status of the host is the power-on status, go to the step 410; otherwise, when determining that the status of the host is the power-off status, go to the step 418.

Step 410: The USB device control circuit outputs a link confirmed signal to the USB Hub control circuit.

Step 412: The USB Hub control circuit outputs the power control signal to the switch unit.

Step 414: The switch unit switches on the input power of the peripheral.

Step 416: The peripheral enters the device power-on status from the device power-off status.

Step 418: End.

As shown in 4B, the method includes the following steps:

Step 452: Start.

Step 454: Receive the signal data from the host via the transmission interface.

Step 456: The USB Hub control circuit detects the signal data received from the host via the transmission interface, so as to determine the status of the host. When determining that the status of the host is the power-off status, go to the step 458; otherwise, when determining that the status of the host is the power-on status, go to the step 464.

Step 458: The USB Hub control circuit outputs the power control signal to the switch unit.

Step 460: The switch unit switches off the input power of the peripheral.

Step 462: The peripheral enters the device power-off status from the device power-on status.

Step 464: End.

Please note that, the steps of the above-mentioned flowcharts are merely practicable embodiments of the present invention, and in no way should be considered to be limitations of the scope of the present invention. These methods can include other intermediate steps or several steps can be merged into a single step without departing from the spirit of the present invention.

In summary, the present invention provides a peripheral capable of connecting with a host and a related power control method. By adding the power control circuit 110 or 210 into the peripheral, it is able to generate the power control signal according to determining the status of the host as the power-on status or the power-off status and to automatically switch on/switch off the input power of the peripheral according to the power control signal. That is to say, the peripheral can be automatically controlled to enter the device power-on status/device power-off status with the power-on status/power-off status of the host, in order to replace the traditional manual manner of switching the status of the peripheral, which can bring more convenience to the user. Herein under a condition that the peripheral is in the device power-off status, the power control circuit switches on the input power of the peripheral when the status of the host is the power-on status, in order to perform the action of automatically powering on the peripheral. Under another condition that the peripheral is in the device power-on status, the power control circuit switches off the input power of the peripheral when the status of the host is the power-off status, in order to perform the action of automatically powering off the peripheral. Therefore, when the host is power off or enters the sleeping mode, the host will release the link between the electronic components of the peripheral (such as the detecting unit 160, the USB Hub control circuit 270, and the USB device control circuit 280) so as to extend the lifetime and hours of use of the electronic components of the peripheral, which can further achieve a goal of saving power consumption.

Those skilled in the art will readily observe that numerous modifications and alterations of the device and method may be made while retaining the teachings of the invention.

What is claimed is:

1. A power control method for a peripheral, wherein the peripheral is capable of connecting with a host via a transmission interface, the method comprising:
receiving signal data from the host via the transmission interface;
determining a status of the host as a power-on status according to the signal data, and a status of the peripheral as a device power-off status, then generating a power control signal; and
switching on an input power of the peripheral according to the power control signal, so as to make the peripheral enter a device power-on status from the device power-off status.

2. The power control method of claim 1, wherein when at least one value of the signal data equals to 1, determining that the status of the host is the power-on status.

3. The power control method of claim 1, wherein the transmission interface is a USB interface, which comprises a D+ port and a D− port; and the peripheral receives the signal data via the D+ port and the D− port and detects the signal data.

4. The power control method of claim 3, wherein when at least one value of the signal data detected by the peripheral via the D+ port and the D− port equals to 1, determining that the status of the host is the power-on status.

5. A power control method for a peripheral, wherein the peripheral is capable of connecting with a host via a transmission interface, the power control method comprising:
receiving signal data from the host via the transmission interface;
determining a status of the host as a power-off status according to the signal data, and the status of the peripheral as a device power-on status, then generating a power control signal; and
switching off an input power of the peripheral according to the power control signal, so as to make the peripheral enter a device power-off status from the device power-on status.

6. The power control method of claim 5, wherein when all values of the signal data equal to 0, determining that the status of the host is the power-off status.

7. The power control method of claim 5, wherein the transmission interface is a USB interface, which comprises a D+ port and a D− port; and the peripheral receives the signal data via the D+ port and the D− port and detects the signal data.

8. The power control method of claim 7, wherein when all values of the signal data detected by the peripheral via the D+ port and the D− port equal to 0, determining that the status of the host is the power-off status.

9. A peripheral capable of connecting with a host, comprising:
a power control circuit, comprising:
a transmission interface, for receiving signal data from the host, wherein the power control circuit connects with the host via the transmission interface;
a detecting unit, coupled to the transmission interface, for determining a status of the host according to the signal data, and for generating a power control signal; and
a switch unit, coupled to the detecting unit, for selectively switching on or switching off an input power of the peripheral according to the power control signal;
wherein when the detecting unit determines the status of the host as a power-on status, and a status of the peripheral as a device power-off status, the detecting unit outputs the power control signal to control the switch unit to switch on the input power, such that the peripheral enters a device power-on status from the device power-off status; and
when the detecting unit determines the status of the host as a power-off status, and the status of the peripheral as the device power-on status, the detecting unit outputs the power control signal to control the switch unit to switch off the input power, such that the peripheral enters the device power-off status from the device power-on status.

10. The peripheral of claim 9, wherein the input power is supplied from a power input port, and the power input port is coupled to the switch unit for supplying needed power to the peripheral.

11. The peripheral of claim 9, wherein:
when the detecting unit detects that at least one value of the signal data equals to 1, the status of the host is determined as the power-on status; and
when the detecting unit detects that all values of the signal data equal to 0, the status of the host is determined as the power-off status.

12. The peripheral of claim 9, wherein the transmission interface is a USB interface, which comprises a D+ port and a D− port; and
the detecting unit receives the signal data via the D+ port and the D− port and detects the signal data.

13. The peripheral of claim 12, wherein:
when the detecting unit detects that at least one value of the signal data received by the D+ port and the D− port equals to 1, the status of the host is determined as the power-on status; and
when the detecting unit detects that all values of the signal data received by the D+ port and the D− port equal to 0, the status of the host is determined as the power-off status.

14. The peripheral of claim 12, wherein the detecting unit comprises a USB Hub control circuit.

15. The peripheral of claim 14, wherein:
when the USB Hub control circuit detects that at least one value of the signal data received by the D+ port and the D− port equals to 1, the status of the host is determined as the power-on status; and
when the USB Hub control circuit detects that all values of the signal data received by the D+ port and the D− port equal to 0, the status of the host is determined as the power-off status.

16. The peripheral of claim 14, wherein the detecting unit further comprises:
a USB device control circuit, coupled to the USB Hub control circuit, for detecting the signal data received by the D+ port and the D− port via the USB Hub control circuit;
wherein when the USB device control circuit detects that at least one value of the signal data received by the D+ port and the D− port equals to 1, the USB device control circuit outputs a link confirmed signal to the USB Hub control circuit.

17. The peripheral of claim 16, wherein when the USB Hub control circuit detects that at least one value of the signal data received by the D+ port and the D− port equals to 1 and receives the link confirmed signal from the USB device control circuit, the USB Hub control circuit determines that the status of the host is the power-on status.
